(19) United States
(12) Patent Application Publication
(10) Pub. No.: US 2007/0284042 A1
(43) Pub. Date: Dec. 13, 2007

(54) Electronic parts removing apparatus and method

(75) Inventor: Keiichi Yamamoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/583,790

(22) Filed: Oct. 20, 2006

(30) Foreign Application Priority Data
Jun. 12, 2006 (JP) 2006-162135

(51) Int. Cl. B29C 63/00

(52) U.S. Cl. 156/344; 361/749; 29/762; 156/584; 29/402.08

(57) ABSTRACT

An electronic parts removing apparatus removes an electronic part from a board. The electronic part is mounted on a board using a thermally-meltable joining material. A holding member is configured to be brought into contact with the electronic parts. A melting apparatus melts the thermally-meltable joining material. A movement detecting part detects a movement of the electronic part. A load applying mechanism applies a load to the electronic part. A drive mechanism moves the holding member in a direction in which the holding member separates from the board. A control part drives the drive mechanism when the movement detecting part detects the movement of the electronic part so as to cause the holding member to move the electronic part in the direction in which the electronic part separates from the board.

### BACKGROUND OF THE INVENTION

1. Field of the Invention

The present invention generally relates to electronic parts removing apparatuses and methods and, more particularly to an electronic parts removing method and apparatus for removing an electronic part, which is mounted on a printed circuit board, from the printed circuit board.

2. Description of the Related Art

When an electronic part, such as a semiconductor chip, a resistor or a capacitor, mounted on a printed circuit board of an electric equipment becomes defective, it is necessary to remove and exchange the defective electronic part from the printed circuit board. Since electronic parts such as a resistor or a capacitor are joined to electrodes of a printed circuit board by a solder, which is a thermally-meltable joining material, it is required to remove the electronic parts after melting the joining solder.

Usually, in order to melt a solder, it is general to use a method to press a heated soldering iron onto a solder-joined part to melt the solder by heat. An electronic part can be removed from the printed circuit board by quickly lifting the electronic part in a state where the solder is melted by being pressed by the soldering iron. In addition to the above-mentioned method using the soldering iron, as a method of melting a solder on a printed circuit board, there are suggested a method of melting a solder by blowing a hot air to a solder-joined part and a method of heating and melting a solder by irradiating a heat ray from a halogen lamp or the like.

Moreover, there is suggested a method to tear off an electronic part such as an IC chip from a printed circuit board without melting a solder by rotating the electronic part using a jig having a recessed part in which the electronic part can be accommodated (for example, refer to Patent Document 1). In this connection, it is suggested to heat the solder by irradiating an infrared ray from a backside of the printed circuit board so as to soften the solder so that the electric part can be easily removed.

Patent Document 1: Japanese Laid-Open Patent Application No. 10-70399

When the solder is melted using a soldering iron, in order to make a solder into a sufficiently melted state, there may be a case where electronic parts or a solder-joined part is heated excessively. In such a case, electrodes and wirings on the printed circuit board are also heated, which results in the electrodes and wirings exfoliating easily. Accordingly, when performing a work (cleaning) to scratch off a remaining solder after removing the electronic part, there is a problem in that the electrodes and wirings exfoliate from the printed circuit board easily by the soldering iron being brought into contact with the electrodes and wirings.

Moreover, in a case where a solder is melted by blowing a hot air or irradiating a heat ray, it is necessary to remove (lift up) from a printed circuit board after the solder is sufficiently melted, but it is difficult to determine instantly whether or not the solder is melted. If an attempt to lift up the electronic part is made before the solder is sufficiently melted, electrodes or wirings of the printed circuit board may be torn off from the printed circuit board together with the electronic part. Accordingly, it is assumed that the solder is completely melted by taking a sufficient heating time and, then, an electronic part removing operation is started. Thus, the printed circuit board and the electronic part may be heated unnecessarily, which raises a problem caused by the unnecessary heating.

The method of removing an electronic part without melting a solder has a merit in that there is no damage due to heat since an electronic part can be removed without applying heat to the printed circuit board. However, since the joined-solder is mechanically cut by an external force, if a joining force of the solder is large, there may be a problem in that electrodes or wirings of the printed circuit board are cut or torn off. Moreover, especially in a case of a small electronic part such as a resistor, a capacitor or the like, it is difficult to exert a large force on the electronic part by utilizing an outer configuration of the electronic part.

### SUMMARY OF THE INVENTION

It is a general object of the present invention to provide an improved and useful electronic parts removing apparatus and method in which the above-mentioned problems are eliminated.

A more specific object of the present invention is to provide an electronic parts removing apparatus and method which can easily detect that a joining material such as a solder or the like is melted, and is capable of removing electronic parts immediately after the joining material is melted.

There is provided according to one aspect of the present invention an electronic parts removing apparatus for removing an electronic part from a board, the electronic part mounted on a board using a thermally-meltable joining material, comprising: a holding member configured to be brought into contact with the electronic parts; a melting apparatus that melts the thermally-meltable joining material mounting the electronic part to the board; a movement detecting part that detects a movement of the electronic part; a load applying mechanism that applied a load to the electronic part; drive mechanism that moves the holding member in a direction in which the holding member separates from the board; and a control part that drives the drive mechanism when the movement detecting part detects the movement of the electronic part, so as to cause the holding member to move the electronic part in the direction in which the electronic part separates from the board.

In the electronic parts removing apparatus according to the present invention, the movement detecting part may include a displacement sensor that detects a displacement of an arm member supporting the holding member. The displacement sensor may be a linear gauge. The load applying mechanism may apply the load to the electronic part by moving the holding member. The load applying apparatus may include the drive mechanism that moves the holding member. The load applying mechanism may apply the load to the electronic part so as to rotate the holding member about a longitudinal axis thereof. The load applying mechanism may be provided separate from the drive mechanism that drives the holding member, and may include a load applying member that contacts the electronic part to apply the load. The melting apparatus may be a heat ray irradiating apparatus that irradiates a heat ray to the electronic part or proximity to the electronic part. The heat ray irradiating apparatus may include a halogen lamp that generates a soft beam as a heat ray, and a lens and a mask for narrowing down the soft beam to a predetermined spot diameter.

Additionally, there is provided according to another aspect of the present invention an electronic parts removing method for removing an electronic part from a board, the electronic part mounted on the board using a thermally-meltable joining material, comprising: heating and curing a thermosetting adhesive and heating the thermally-meltable joining material in a state where a holding member is pressed against the electronic part via the thermosetting adhesive; detecting a movement of the electronic part while heating the thermally-meltable joining material; and removing the electronic part from the board by moving the holding member in a direction of separating the holding member from the board immediately after the movement of the electronic part is detected.

In the electronic parts removing method according to the present invention, a thermosetting resin having a curing temperature lower than a melting temperature of the thermally-meltable joining material is used as the thermosetting adhesive. The heating and curing of the thermosetting adhesive and the heating of the thermally-meltable joining material may be performed by irradiating a heat ray to or proximity of the electronic part. After curing the thermosetting adhesive by irradiating the heat ray so as to firmly fix the electronic part to the holding member, the heat ray is continuously irradiated to the thermally-meltable joining material so as to-melt the thermally-meltable joining material. The holding member may be moved in the direction of separating the holding member from the board immediately after the movement of the electronic part is detected, and simultaneously the irradiation of the heat ray may be stopped.

According to the present invention, it can be determined whether or not the thermally-meltable joining material is melted by detecting a movement of the electronic part. That is, the electronic part slightly moves due to a load being applied to the electronic part when the thermally-meltable joining material is melted, and, thus, it can be determined that the thermally-meltable joining material is melted at the time when the movement of the electronic part is detected. Therefore, by proceeding to a process of removing the electronic part immediately after the movement of the electronic part is detected, the process of removing the electronic part is prevented from being started before the thermally-meltable joining material is melted, and also an excessive heating due to continuous heating after the thermally-meltable joining material is melted is prevented. Thereby, the electronic part can be removed while maintaining electrodes and wirings on the board in a good state.

Other objects features and advantages of the present invention will become more apparent from the following detailed description when read in conjunction with the accompanying drawings.

### BRIEF DESCRIPTION OF THE DRAWINGS

FIG. 1 is an illustrative side view of an electronic parts removing apparatus according to an embodiment of the present invention;

FIG. 2 is a front view of a nozzle part shown in FIG. 1;

FIG. 3 is a perspective view showing an arm and the nozzle shown in FIG. 1;

FIG. 4 is an illustration showing a structure of an arm support part;

FIG. 5 is an illustration showing a process from an application of a load to an electronic part to a removal of the electronic part;

FIG. 6 is an illustration showing another example of a load application mechanism;

FIG. 7 is an illustration showing a further example of the load application mechanism; and

FIG. 8 is a perspective view showing an outline of a rework apparatus containing the electronic parts removing apparatus shown in FIG. 1.

### DETAILED DESCRIPTION OF THE PREFERRED EMBODIMENTS

A description will be given below, with reference to the drawings, of an embodiment according to the present invention.

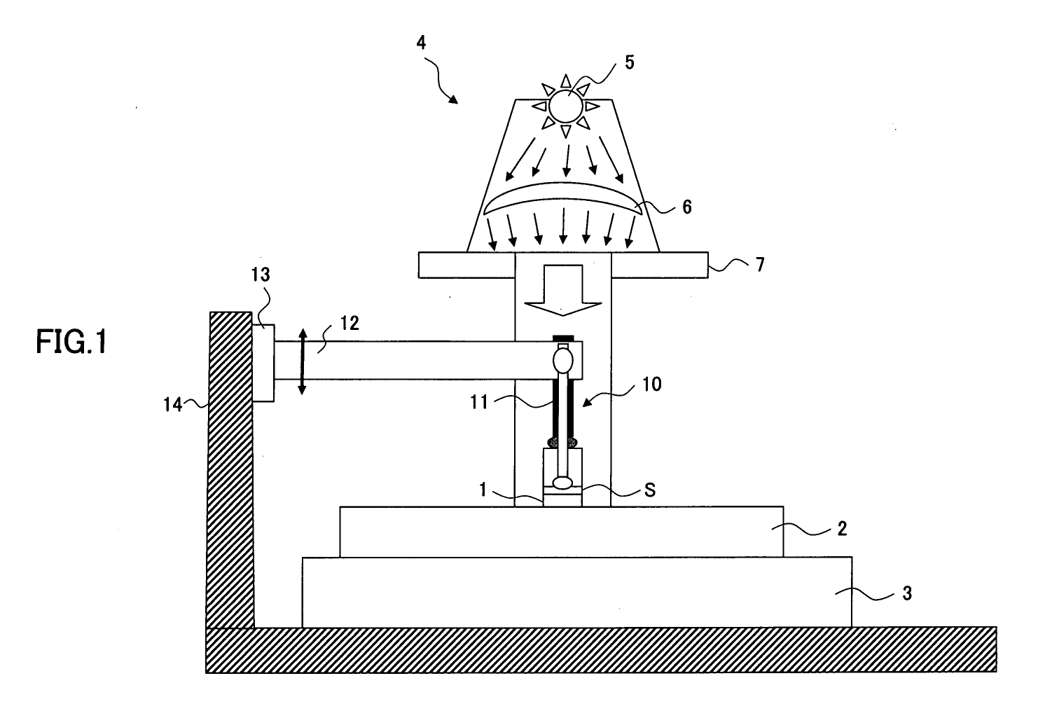

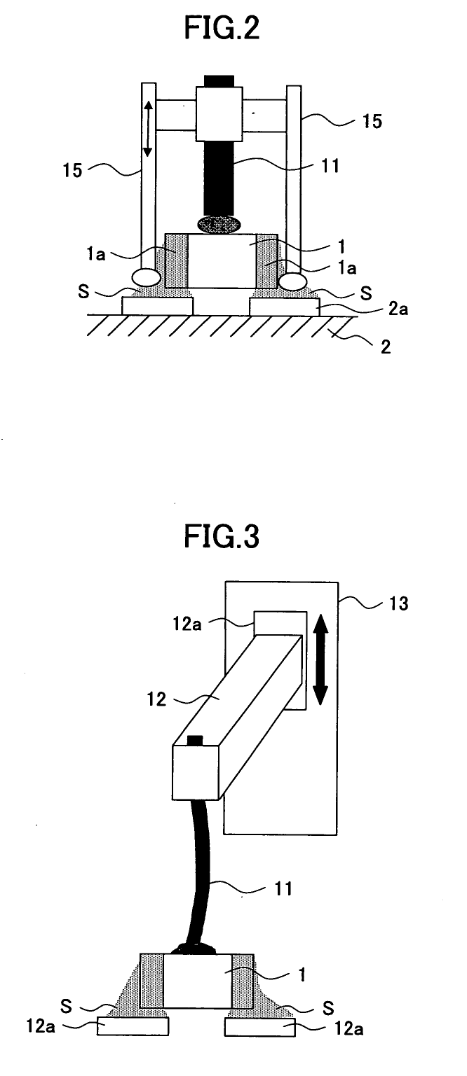

FIG. 1 is an illustrative side view of electronic parts removing apparatus according to an embodiment of the present invention. The electronic parts removing apparatus shown in FIG. 1 is an apparatus for removing an electronic part 1 from a printed circuit board 2 to which the electronic part 1 is mounted. FIG. 2 is a front view of a nozzle part shown in FIG. 1.

The electronic part 1 may be an active element such as a semiconductor device or a passive element such as a resistor element or a capacitor element. Here, for example, the electronic part 1 is a passive element of 06-03 (length 6 mm, width 3 mm, height 3 mm). Electrodes 1a are formed on opposite ends of the electronic part 1. The electrodes 1a are joined to pattern wirings (or pattern electrodes) 2a on the printed circuit board 2 by a thermally-meltable joining material.

The thermally-meltable joining material is a joining material such as a solder, a silver solder or the like which melts by heat and joins metal members when solidified. Here, a solder is used as the thermally-meltable joining material. The solder may be any kind of solder such as an eutectic solder, a lead-free solder, etc. The printed circuit board 2 is a board provided with pattern wirings on a mounting surface thereof. The printed circuit board 2 may be any kind of board such as a flexible printed circuit board, a rigid printed circuit board, etc.

The printed circuit board 2 on which the electronic part 1 is mounted by the solder S is placed on an XY-stage part 3. The XY-stage part 3 is capable of moving in a horizontal direction so as to horizontally move the printed circuit board 2 to a predetermined position. Above the XY-stage part 3, a heat ray irradiation apparatus is arranged as a heat source. The heat ray irradiation apparatus 4 includes, for example, a halogen lamp 5 which generates a soft beam as a heat ray. The soft beam radiated from the halogen lamp 5 is narrowed down to a small spot diameter by an aperture lens 6 and a mask 7, and is irradiated onto the printed circuit board 2. The spot diameter of the soft beam is narrowed down to a size which can cover the entire electronic part 1 or proximity of the electronic part 1. It should be noted that although the heat ray irradiation apparatus 4 functions as a melting apparatus which heats and melts the thermally-meltable joining material by irradiating a heat ray, the melting apparatus may be an apparatus that heats the thermally-meltable joining material according to other methods such as blowing a hot air or contacting a heating member such as a soldering iron.

The nozzle part 10 is arranged between the XY-stage part 3 and the heat ray irradiation apparatus 4. The nozzle part 10 has a nozzle 11 which is a holding member for holding the electronic part 1 as shown also in FIG. 2. The nozzle 11 is an elongated member of a rod-shape or a tube shape made of, for example, copper or a stainless steel. The nozzle 11 is mounted at the end of an arm part 12, which is movable in a direction perpendicular to a placement surface of the XY-stage part 3. The arm part 12 extends from an arm support part 13 in a horizontal direction. The arm part 12 is moved in the direction perpendicular to the placement surface of the XY-stage part 3 by the arm support part 13 moving along a shaft part 14.

As shown in FIG. 2, side pins 15 are arranged on both sides of the nozzle 11. An extreme end of each side pin 15 extends downward from the end of the nozzle 11, and extends along a side surface of the electronic part 1 in a state where the end of the nozzle is in contact with an upper surface of the electronic part 1 so that the extreme end of the side pin 15 is brought into contact with a solder S. Additionally, each side pin 15 incorporates therein a spring structure so as to be movable slightly in the vertical direction. According to the spring structure incorporated in the side pin 15, the nozzle 11 can be moved downward even after the extreme end of the side pin 15 is brought into contact with the solder S.

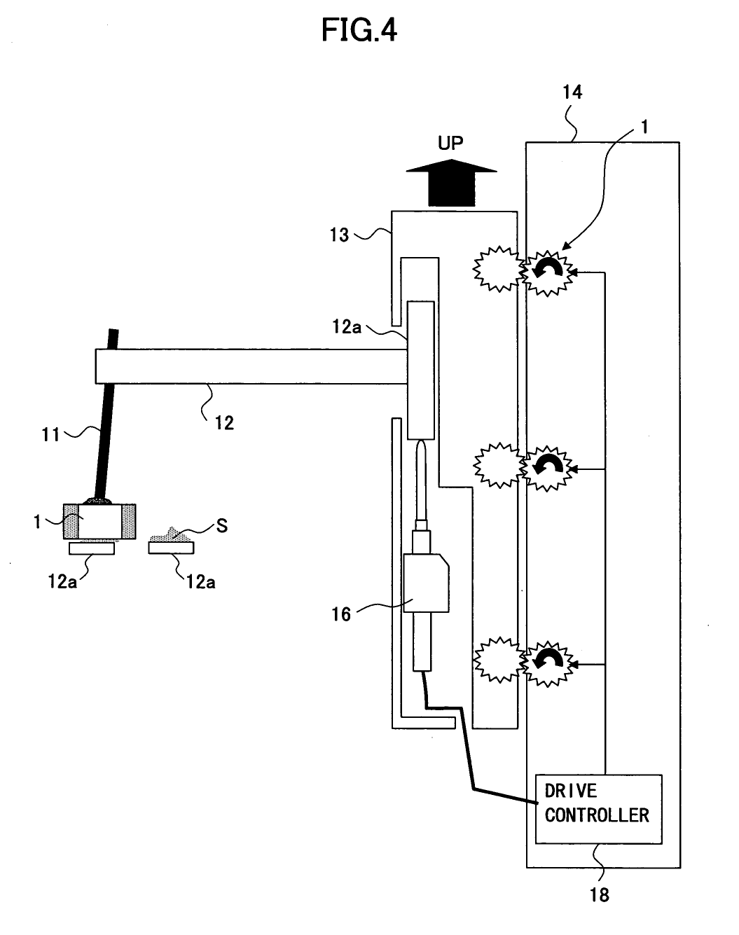

FIG. 3 is a view showing the arm part and the nozzle shown in FIG. 1. FIG. 4 is an illustration showing a structure of the arm support part 13. It should be noted that the side pins are omitted in FIG. 3 and FIG. 4 for the sake of simplification of the drawings.

The nozzle 11 is attached at the end of the arm part 12, and an arm movable part 12a is provided at the opposite side of the end where the nozzle 11 is attached. A displacement sensor 16 is provided to the arm movable part 12a so as to detect a small displacement of the arm movable part 12a. As for the displacement sensor 16, a linear gauge sensor is used in the example shown in FIG. 4, which optically detects a minute movement of the spindle so as to output an electric signal. Besides, other well-known detectors such as a strain gauge, a micro switch or the like may be used as the displacement sensor 16. The displacement sensor 16 is provided for detecting a displacement of the arm movable part 12a when the electronic part 1 is moved as mentioned above.

As shown in FIG. 4, the arm support part 13 is movable along the shaft part 14 according to the drive mechanism 17. As the drive mechanism 17, a well-known linear movement mechanism such as a gear structure using a motor as a drive source, a rack and pinion structure, or the like may be used. A detection signal (electric signal) from the displacement sensor 16 is supplied to a drive controller 18, which is a control part. If the drive controller 18 determines that the arm movable part 12a is displaced based on the output signal of the displacement sensor 16, the drive controller 18 drives a motor (not shown in the figure) of the drive mechanism 17 to drive the drive mechanism 17 so as to move the arm support part 13 in a direction (a vertical direction indicated by an arrow in FIG. 4) in which the nozzle 11 is separated from the electronic part 1. The determination of the displacement of the arm movable part 12a can be made when it reaches a predetermined amount of displacement, or when an amount of displacement per unit time calculated exceeds a predetermined amount.

A description will now be given of the load applying mechanism for applying a load to the electronic part.

In order to minutely move the electronic part 1 at the time when the solder S melts, it is necessary to apply a small load to the electronic part 1 beforehand. For example, a pressing force exerted by the nozzle 11 can be such a load. By pressing an upper surface of the electronic part 1 by the nozzle 11 by driving the drive mechanism 17 that drives the arm support part 13, the electronic part 1 minutely moves in a downward direction or a transverse direction at the same time the solder S melts. Such a minute movement appears in a minute displacement of the arm movable part 13 via the nozzle 11 and the arm part 12. Thus, by detecting the displacement of the arm movable part 13 by the displacement sensor 16, the movement of the electronic part can be detected. In this case, the structure including the nozzle 11, the arm part 12, the arm movable part 12a, the arm support part 13 and the drive mechanism 17 constitutes the load applying mechanism for applying a load to the electronic part 1.

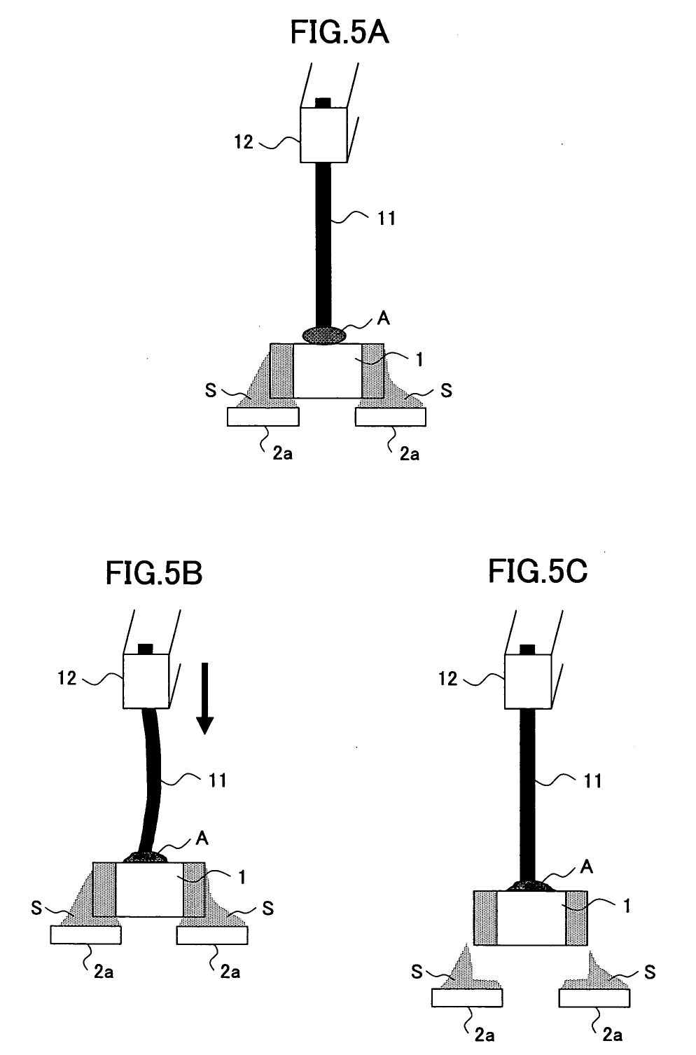

FIGS. 5A through 5C are illustrations showing a process from application of a load to the electronic part 1 to a removal of the electronic part 1.

As shown in FIG. 5A, the drive mechanism 17 is driven first so as to cause the end of the nozzle 11 to be in contact with the upper surface of the electronic part 1. At this time, a thermosetting adhesive A is applied previously onto the upper surface of the electronic part 1, and the end of the nozzle 11 is brought into contact with the upper surface of the electronic part 11 via the thermosetting adhesive A. The thermosetting adhesive A is made of a thermosetting resin which is curable by heat.

Next, as shown in FIG. 5B, a soft beam is irradiated from the heat ray irradiation apparatus 4 to the entire electronic part 1 or proximity of the electronic part 1 while pressing the nozzle 11 against the electronic part 1. The thermosetting adhesive A and the solder S are heated by the soft beam, and the temperatures thereof rise. Since the curing temperature (for example, 130° C.) of the thermosetting adhesive A is lower than the melting temperature (for example, 230° C.) of the solder S, the thermosetting adhesive A is cured before the solder S is melted and the electronic part 1 is fixed to the end of the nozzle 11. The irradiation of the soft beam is continued after the thermosetting adhesive A is cured, and, thus, the solder S is heated and reaches the melting temperature. When the solder S is melted, there is no fixing force applied to the electronic part 1 by the solder S, and, thus, the electronic part 1 minutely moves in a downward direction or a transverse direction due to a load being applied to the electronic part 1. The minute movement of the electronic part 1 appears as a displacement of the arm movable 12a and is detected by the displacement sensor 16.

As mentioned above, when the movement of the electronic part 1 is detected, the drive controller 18 drives the drive mechanism 17 so as to move the nozzle 11 together with the arm part 12 as shown in FIG. 5C. When the nozzle 11 moves upward, the electronic part 1 also moves upward together with the nozzle 11 since the electronic part 1 has been fixed to the nozzle 11 by the thermosetting adhesive A, which has already been cured, and, thereby, the electronic part 1 is removed from the printed circuit board 2.

It should be noted that a description of an action of the side pins 15 is omitted in the above-mentioned description with reference to FIGS. 5A through 5C.

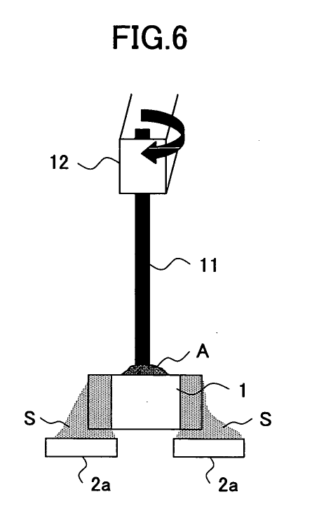

The load applying mechanism is not limited to the above-mentioned example, and may apply a load to the electronic part 1 according to various methods. For example, as shown in FIG. 6, a load to rotate the electronic part 1 may be applied by providing a mechanism for giving a rotational force (torsion) to the nozzle 11. In such a case, a reactive force of the rotational force applied to the nozzle 11 is exerted on the arm movable part 12a via the arm part 12. Thus, by detecting a displacement due to the reactive force and if it is detected that a displacement of the arm movable part 12a is eliminated due to elimination of the reactive force when the electronic part 1 is rotated, the movement (rotation) of the electronic part 1 can be detected. It should be noted that the rotational force to be applied to the nozzle 11 must be applied after the thermosetting adhesive A reaches the curing temperature and it is cured.

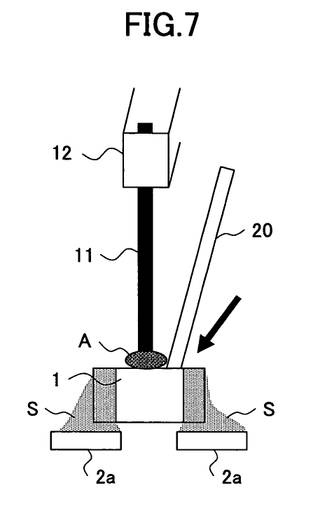

Alternatively, as shown in FIG. 7, a load applying member 20 to be brought into contact with the electronic part 1 may be provided other than the nozzle 11 so as to press the electronic part 1 in a transverse direction. When the solder S melts, the electronic part 1 moves in a transverse direction due to the load (pressing force) by the load applying member 20. By detecting the displacement of the arm movable part 12a by the movement in the transverse direction, the detection of the electronic part 1 can be achieved.

Although the above-mentioned movement detection part for the electronic part 1 detects the movement of the electronic part 1 by detecting the displacement transmitted to the arm movable part 12a via the nozzle 11 and the arm part 12, the displacement sensor may be provided independently of the nozzle 11 and the arm part 12. For example, an image recognition camera may be provided so as to detect a movement of the electronic part 1 according to image recognition.

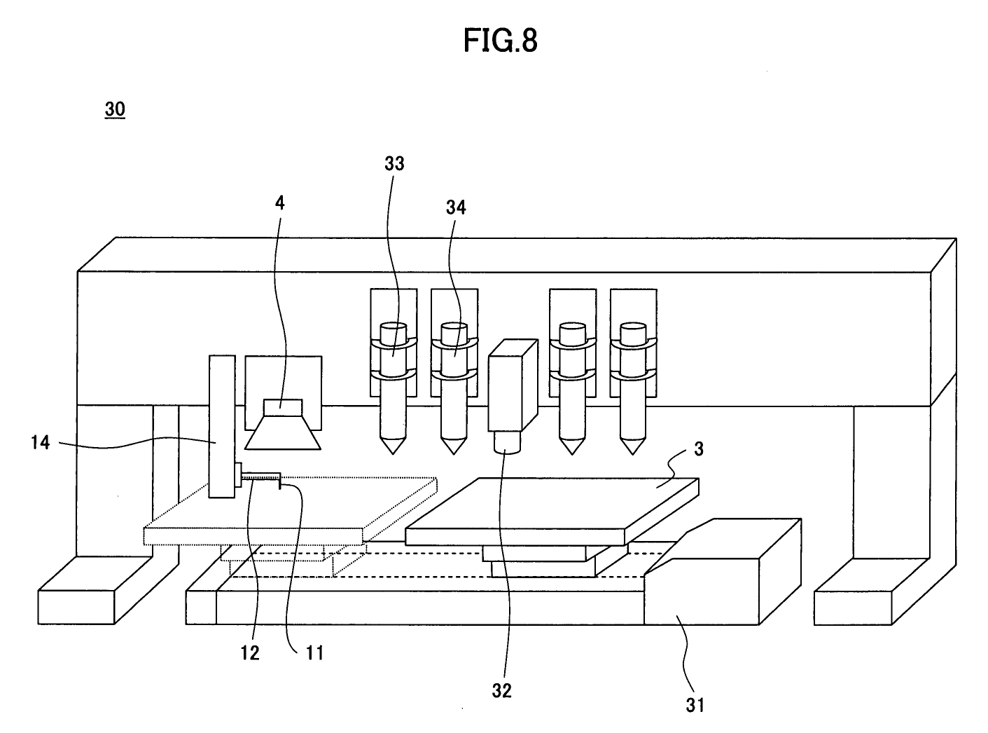

A description will now be given in more detail, with reference to also FIG. 8, of an electronic parts removing method performed by the electronic parts removing apparatus shown in FIG. 1. FIG. 8 is a perspective view showing an outline of a rework apparatus including the electronic parts removing apparatus shown in FIG. 1.

In order to remove the electronic product 1 mounted on the printed circuit board 2, first, the printed circuit board 2 is placed on the XY-stage part 3 on a stage moving apparatus 30, and image recognition of the electronic part 1, which is mounted on the printed circuit board 2 and to be removed, is performed by a recognition camera 32. Then, the XY-stage part 3 is moved so that the electronic part 1 to be removed is located directly under an adhesive dispenser 33 and the thermosetting adhesive A is applied onto the upper surface of the electronic part 1. It should be noted that the thermosetting adhesive A may be transferred to an end of the nozzle 11 instead of applying the thermosetting adhesive A onto the upper surface of the electronic part 1.

Then, a post flux F is transferred to the ends of the side pins 15 provided on both sides of the nozzle part 10 (the post flux F is shown in FIG. 1 and FIG. 2). Then, the XY-stage part 3 is moved so as to locate the electronic part 1, which is to be removed, directly under the nozzle 11. It should be noted that the post flux F is supplied by a post flux dispenser 34.

Subsequently, the drive mechanism 17 of the shaft part 14 is driven so as to move the nozzle downward, and the end of the nozzle 11 is brought into contact with the upper surface of the electronic part 1. At this time, the side pins 15 move downward together with the nozzle 11 and are brought into contact with the solder S. Since the spring structure is incorporated in each side pin 15 as mentioned above, the end of each side pin 15 and the end of the nozzle 11 can be brought into contact with the solder S and the upper surface of the electronic part 1, respectively, due to the slight downward movement of the nozzle 11 after the side pins 15 contact the solder S. The end of the nozzle 11 is in contact with and pressed against the upper surface of the electronic part 1, and is maintained in a state where the load is applied to the electronic part 1 by the nozzle 11.

Then, a soft beam is irradiated from the heat ray irradiation apparatus 4 to the electronic part 1 so that the soft beam is irradiated onto the thermosetting adhesive A on the electric part 1 and the solder S. Thereby, the thermosetting adhesive A is heated and cured and the electronic part 1 is fixed to the end of the nozzle 11. By continuously irradiating the soft beam, the solder S reaches the melting temperature and is melted. At this time, a load is applied to the electronic part 1 by the nozzle 11, the electronic part 1 minutely moves at the same time the solder S melts. Additionally, when the solder S is melted, the solder S is in a fluidized state and the side pins 15 move further downward according to the spring structure. Since the post flux F has been transferred to the side pins 15, the melted solder S is attracted by the side pins 15 and adheres to the side pins 15.

When the electronic part 1 moves minutely, a displacement of the arm movable part 12a is detected. Thus, the drive mechanism 17 is driven and the arm part 12 moves upward. Thereby, the nozzle 11 and the side pins 15 move upward, and the electronic part 1 fixed to the end of the nozzle 11 is removed from the printed circuit board 2 and a large part of the solder S is removed from the wiring pattern 2a in a state where the solder S adheres onto the side pins 15A. Additionally, a part of the post flux F transferred to the side pins 15 moves to the wiring pattern 2a. Thus, the solder S remaining on the wiring pattern 2a becomes a thin fillet-shape (so-called solder fillet) on the wiring pattern 2a.

Moreover, while the drive mechanism 17 starts the operation to move the nozzle 11 upward, the irradiation of the soft bean from the heat ray irradiation apparatus 4 is stopped so as to stop the heating of the electronic part 1.

As mentioned above, since the electronic part 1 is removed immediately after the solder S melts and the heating is stopped, the printed circuit board 2 is prevented from being unnecessarily heated for a long time, which can reduce thermal damage given to the wiring pattern 2a of the printed circuit board 2 and peripheral electronic parts as much as possible.

Moreover, since the electronic part 1 is removed after determining that the solder S has been actually melted, there is no need to perform a preliminary step in which a heating time is previously set by checking a time needed for melting the solder S first, thereby causing the solder S to melt easily and remove the electronic part 1. For example, the time needed for melting the solder S may vary depending on a kind and an amount of the solder S. However, according to the above-mentioned method, even if a kind and an amount of the solder S is not known, the solder S can be easily melted and the electronic part 1 can be removed immediately.

The present invention is not limited to the specifically disclosed embodiments, and variations and modifications may be made without departing from the scope of the present invention.

The present application is based on Japanese priority application No. 2006-162135 filed Jun. 12, 2006, the entire contents of which are hereby incorporated herein by reference.

What is claimed is:

1. An electronic parts removing apparatus for removing an electronic part from a board, the electronic part mounted on a board using a thermally-meltable joining material, comprising:
a holding member configured to be brought into contact with the electronic parts;
a melting apparatus that melts said thermally-meltable joining material mounting said electronic part to said board;
a movement detecting part that detects a movement of said electronic part;
a load applying mechanism that applied a load to said electronic part;
a drive mechanism that moves said holding member in a direction in which said holding member separates from said board; and
a control part that drives said drive mechanism when said movement detecting part detects the movement of said electronic part, so as to cause said holding member to move said electronic part in the direction in which said electronic part separates from said board.

2. The electronic parts removing apparatus as claimed in claim 1, wherein said movement detecting part includes a displacement sensor that detects a displacement of an arm member supporting said holding member.

3. The electronic parts removing apparatus as claimed in claim 2, wherein said displacement sensor is a linear gauge.

4. The electronic parts removing apparatus as claimed in claim 1, wherein said load applying mechanism applies the load to said electronic part by moving said holding member.

5. The electronic parts removing apparatus as claimed in claim 4, wherein said load applying apparatus includes said drive mechanism that moves said holding member.

6. The electronic parts removing apparatus as claimed in claim 4, wherein said load applying mechanism applies the load to said electronic part so as to rotate said holding member about a longitudinal axis thereof.

7. The electronic parts removing apparatus as claimed in claim 4, wherein said load applying mechanism is provided separate from said drive mechanism that drives said holding member, and includes a load applying member that contacts said electronic part to apply the load.

8. The electronics parts removing apparatus as claimed in claim 1, wherein said melting apparatus is a heat ray irradiating apparatus that irradiates a heat ray to said electronic part or proximity to said electronic part.

9. The electronics parts removing apparatus as claimed in claim 8, wherein said heat ray irradiating apparatus includes a halogen lamp that generates a soft beam as a heat ray, and a lens and a mask for narrowing down the soft beam to a predetermined spot diameter.

10. An electronic parts removing method for removing an electronic part from a board, the electronic part mounted on the board using a thermally-meltable joining material, comprising:
heating and curing a thermosetting adhesive and heating the thermally-meltable joining material in a state where a holding member is pressed against the electronic part via the thermosetting adhesive;
detecting a movement of said electronic part while heating the thermally-meltable joining material; and
removing said electronic part from said board by moving said holding member in a direction of separating said holding member from said board immediately after the movement of said electronic part is detected.

11. The electronic parts removing method as claimed in claim 10, wherein a thermosetting resin having a curing temperature lower than a melting temperature of said thermally-meltable joining material is used as said thermosetting adhesive.

12. The electronic parts removing method as claimed in claim 10, wherein the heating and curing of the thermosetting adhesive and the heating of said thermally-meltable joining material are performed by irradiating a heat ray to or proximity of said electronic part.

13. The electronic parts removing method as claimed in claim 11, wherein after curing said thermosetting adhesive by irradiating the heat ray so as to firmly fix said electronic part to said holding member, the heat ray is continuously irradiated to said thermally-meltable joining member so as to melt said thermally-meltable joining member.

14. The electronic parts removing method as claimed in claim 10, wherein said holding member is moved in the direction of separating said holding member from said board immediately after the movement of said electronic part is detected, and simultaneously the irradiation of the heat ray is stopped.
